(19) United States
(12) Patent Application Publication
(10) Pub. No.: US 2016/0237238 A1
(43) Pub. Date: Aug. 18, 2016

(54) POLYETHYLENE COMPOSITION FOR INJECTION MOLDING

(71) Applicant: BASELL POLYOLEFINE GMBH, Wesseling (DE)

(72) Inventor: Bernd Hoecker, Wiesbaden (DE)

(73) Assignee: Basell Polyolefine GmbH, Wesseling (DE)

(21) Appl. No.: 15/029,985

(22) PCT Filed: Sep. 24, 2014
(86) PCT No.: PCT/EP2014/070321

§ 371 Date: Apr. 15, 2016

(30) Foreign Application Priority Data
Oct. 15, 2013 (EP) 13188690.5

(51) Int. Cl. C08K 3/04; B65D 25/02

(52) U.S. Cl. CPC C08K 3/04; B65D 25/02

(57) ABSTRACT

A polyethylene composition having density from 0.943 to 1.1 g/cm³, comprising:
A) carbon black, or a UV stabilizer, or a mixture of carbon black and a UV stabilizer;
B) a polyethylene comprising copolymers of ethylene with 1-alkenes, or mixtures of ethylene homopolymers and said copolymers of ethylene with 1-alkenes, which polyethylene has molar mass distribution width (MWD) M_{w}/Mₙ of from 7 to 15, density of from 0.942 to 0.954 g/cm³, a weight average molar mass M_{w} of from 20,000 g/mol to 500,000 g/mol, a MIE of from 1.0 to 3.0 g/10 min, a MIF of from 100 to 200 g/10 min, and a ratio MIF/MIE of from 40 to 50.

### FIELD OF THE INVENTION

The present disclosure relates to a novel polyethylene composition for the injection molding of large, hollow objects, comprising carbon black and/or a UV stabilizer.

### BACKGROUND OF THE INVENTION

Injection molding is a molding technique suitable for molding small to large objects. A mold is generated in dedicated injection molding machines comprising a rotating screw in a barrel. The mold is injected continuously or with a mold buffer by means of pressure.

If the injectable object is large and complicated in shape, the pressure has to be very high in order to completely fill the cavity. Often several hot runners are used to overcome the high pressure level and to generate an even temperature profile while injecting polyethylene, in order to minimize the warpage of the injected large, hollow objects. Such objects often contain carbon black and/or a UV stabilizer.

Examples of polyethylene for injection molding, particularly suited for preparing screw closures, are disclosed in WIPO Pat. App. Pub. No. WO2005103096.

### SUMMARY OF THE INVENTION

The objective of the present disclosure is to devise a new, improved injection molding polyethylene composition containing carbon black and/or a UV stabilizer and having a valuable balance of properties, e.g. for injected half shells for tanks, avoiding high warpage and making it possible to lower the injection molding pressure generally required in the production of large, hollow objects.

This objective is addressed by the novel polyethylene composition of the present disclosure.

The present disclosure provides a polyethylene composition having density from 0.943 to 1.1 g/cm³, including from 0.945 to 0.980 g/cm³, comprising:
A) carbon black, or a UV stabilizer, or a mixture of carbon black and a UV stabilizer;
B) a polyethylene composition comprising copolymers of ethylene with 1-alkenes, or mixtures of ethylene homopolymers and copolymers of ethylene with 1-alkenes, where polyethylene has molar mass distribution width (MWD) M_{w}/Mₙ of from 7 to 15, a density of from 0.942 to 0.954 g/cm³ determined according to ISO 1183 at 23° C., a weight average molar mass M_{w} of from 20,000 g/mol to 500,000 g/mol, a MIE of from 1.0 to 3.0 g/10 min, a MIF of from 100 to 200 g/10 min, including from 110 to 150 g/10 min, and a ratio MIF/MIE of from 40 to 50, where MIE is the melt flow rate at 190° C. with a load of 2.16 kg and MIF is the melt flow rate at 190° C. with a load of 21.6 kg, both determined according to ISO 1133.

### DETAILED DESCRIPTION OF THE INVENTION

In some embodiments, the polyethylene composition of the present disclosure comprises 0.25 to 50% by weight of carbon black and/or 0.01 to 10% by weight of a UV stabilizer A), such as from 0.5 to 2% by weight of carbon black and/or 0.01 to 2% by weight of a UV stabilizer A), including from 0.5 to 2% by weight of carbon black and 0.01 to 1% by weight of a UV stabilizer A), with all amounts referring to the total weight of A)+B).

Examples of carbon black and UV stabilizers are the carbon black Elftex TP, sold by Cabot, and the hindered amine light stabilizers (HALS), such as those sold by BASF with the trademark Tinuvin. In general, all the kinds of carbon black and UV stabilizers commonly employed in polyethylene compositions are suited for use according to the present disclosure.

Examples of suitable 1-alkenes in the copolymers B) are C₃-C₂₀-alpha-olefins such as propene, 1-butene, 1-pentene, 1-hexene, 4-methyl-1-pentene, 1-heptene or 1-octene.

According to the present disclosure, a copolymer is as a co-polymer of ethylene with at least one comonomer, that is, a “copolymer” according to the present disclosure also encompasses ter-polymers and higher, multiple co-monomer co-polymerizates. As opposed to a homopolymer, a co-polymer may comprise at least greater than 3.5% by weight of a co-monomer in addition to ethylene, based on the total weight of the copolymer. In some embodiments, a “copolymer” is a truly binary co-polymerizate of ethylene and substantially one species of co-monomer only. “Substantially one species” means, in certain embodiments, that greater than 97% by weight of co-monomer amounts to one kind of co-monomer molecule.

In further embodiments, the polyethylene B) has a CDBI of 20-70%, such as from 20% to less than 50%. The CDBI (composition distribution breadth index) is a measure of the breadth of the distribution of the composition. This value is described in WIPO Pat. App. Pub. No. WO 93/03093. The CDBI is defined as the weight percent of the copolymer molecules having co-monomer contents of ±25% of the mean molar total co-monomer content, i.e. the share of co-monomer molecules whose co-monomer content is within 50% of the average co-monomer content. This is determined by TREF (temperature rising elution fraction) analysis (Wild et al., J. Poly. Phys. Ed., vol. 20. (1982) and U.S. Pat. No. 5,008,204). Optionally, it may be determined by crystallization analysis fractionation (CRYSTAF) analysis.

In certain embodiments, the polyethylene B) has a weight average molar mass M_{w} of from 40,000 g/mol to 200,000 g/mol and from 50,000 g/mol to 150,000 g/mol. In further embodiments, the z average molar mass M_{z} of the polyethylene B) is in the range of less than 10⁶ g/mol, such as from 200,000 g/mol to 800,000 g/mol. The definition of z-average molar mas M_{z} is defined in Peacock, A. (ed.), Handbook of PE, and High Polymers, vol. XX, Raff and Doak, Interscience Publishers, John Wiley & Sons, 1965, S. 443.

The definition of M_{w}, Mₙ and MWD can be found in the “Handbook of PE”, ed. A. Peacock, p. 7-10, Marcel Dekker Inc., New York/Basel 2000. The determination of Mₙ, M_{w} and M_{w}/Mₙ derived therefrom was carried out by high-temperature gel permeation chromatography using a method described in DIN 55672-1: 1995-02, February 1985. The specific conditions used according to the mentioned DIN standard are as follows: solvent: 1,2,4-trichlorobenzene (TCB); temperature of apparatus and solutions: 135° C.; and concentration detector: PolymerChar (Valencia, Paterna 46980, Spain) IR-4 infrared detector, suitable for use with TCB. Further details are given in the examples.

In additional embodiments, the amount of weight fraction of the polyethylene B) having a molar mass of less than 10⁶ g/mol, as determined by GPC for standard determination of the molecular weight distribution, is above 95.5% by weight, including above 96% by weight and above 97% by weight. This value may be determined by applying the WIN-GPC software of the company “HS-Entwicklungsgesellschaft fur wissenschaftliche Hard- and Software mbH”, Ober-Hlbersheim/Germany, for instance.

It is clear that for injection molding a very good flowing polyethylene has advantages in processing, however a good flowability in the molten state is difficult to achieve, especially when the polyethylene has very long chains, because this characteristic oftens leads to warpage. The polyethylene B) allows for long polyethylene chains, but still provides high flowability and low warpage of the hollow bodies.

The polyethylene B) may be monomodal or multimodal, that is at least bimodal, as determined by high temperature gel permeation chromatography analysis (high temperature GPC for polymers according to the method described in DIN 55672-1: 1995-02 (February 1995) with specific deviations made as referenced above, in the section on determining M_{w}, Mₙ by means of HT-GPC). The molecular weight distribution curve of the GPC-multimodal polymer can be looked at as the superposition of the molecular weight distribution curves of the polymer sub-fractions which will show two or more distinct maxima or will be distinctly broadened compared with the curves for the individual fractions. A polymer showing such a molecular weight distribution curve is called “bimodal” or “multimodal” with regard to GPC analysis, respectively. Such GPC-multimodal polymers can be produced according to several processes, e.g. in a multi-stage process in a multi-step sequence as described in WIPO Pat. App. Pub. No. WO 92/12182.

In one embodiment, optionally in conjunction with employing a mixed system of at least two single-site catalysts, the polyethylene B) has a substantially monomodal molecular mass distribution curve as determined by GPC and is monomodal in GPC, because the individual molecular weight distributions of polymer sub-fractions overlap and do not resolve as to display two distinct maxima any more. Modality in the present context is defined as the number of instances where the value of the differential function mass distribution is 0 (i.e. slope 0) and the differential value changes from positive to negative sign for increasing molar masses at the point having a functional value of 0. The mass distribution curve is not required to be perfectly bell-shaped; therefore it is merely “substantially” monomodal. In certain embodiments, such monomodal distribution is obtained in situ in a one-pot reaction with a mixed or hybrid catalyst system, such as with mixed single-site catalysts, giving rise to a particularly homogenous, insitu mixture of different catalyst products where homogeneity is generally not obtainable by conventional blending techniques.

The polyethylene B) has, in certain embodiments, at least 0.6 vinyl groups/1,000 carbon atoms, e.g. from 0.6 up to 2 vinyl groups/1,000 carbon atoms, from 0.9 to 10 vinyl groups/1,000 carbon atoms and from 1 to 5 vinyl groups/1,000 carbon atoms, and from 1.2 to 2 vinyl groups/1,000 carbon atoms. The content of vinyl groups per 1,000 carbon atoms is determined by means of IR, according to ASTM D 6248-98. For the present purpose, the expression “vinyl groups” refers to —CH═CH₂ groups; vinylidene groups and internal olefinic groups are not encompassed by this expression. Vinyl groups are usually attributed to a polymer termination reaction after an ethylene insertion, while vinylidene end groups are usually formed after a polymer termination reaction after a co-monomer insertion. In some embodiments, at least 0.9 vinyl groups/1,000 carbon atoms, such as 1 to 3 vinyl groups/1,000 carbon atoms and 1.3 to 2 vinyl groups/1,000 carbon atoms are present in the 20% by weight of the polyethylene having the lowest molar masses. This concentration can be determined by solvent-non-solvent fractionation, later called Holtrup fractionation as described in W. Holtrup, Markomol. Chem. 178, 2335 (1977), coupled with IR measurement of the different fractions, with the vinyl groups being measured in accordance with ASTM D 6248-98. Xylene and ethylene glycol diethyl ether at 130° C. are used as solvents for the fractionation. 5 g of polymer are used and are divided into 8 fractions.

The polyethylene B) has, in certain embodiments, at least 0.005 vinylidene groups/1,000 carbon atoms, such as from 0.1 to 1 vinylidene groups/1,000 carbon atoms and from 0.14 to 0.4 vinylidene groups/1,000 carbon atoms. The determination is carried out by IR measurement in accordance with ASTM D 6248-98.

The polyethylene B) has, in certain embodiments, from 0.7 to 20 branches/1,000 carbon atoms, from 0.7 to 10 branches/1,000 carbon atoms and from 1.5 to 8 branches/1,000 carbon atoms. The branches/1,000 atoms are determined by means of ¹³C NMR, as described by James C. Randall, JMS-REV. Macromol. Chem. Phys. C29 (2&3), 201-317 (1989), and refer to the total content of CH₃ groups/1,000 carbon atoms.

¹³C NMR high temperature spectra of polymer are acquired on a Bruker DPX-400 spectrometer operating at 100.61 MHz in the Fourier transform mode at 120° C.

The peak S₆₆ [C. J. Carman, R. A. Harrington and C. E. Wilkes, Macromolecules, 10, 3, 536 (1977)] carbon is used as an internal reference at 29.9 ppm. The samples are dissolved in 1,1,2,2-tetrachloroethane-d2 at 120° C. with a 8% wt/v concentration. Each spectrum is acquired with a 90° pulse, 15 seconds of delay between pulses and CPD (WALTZ 16) to remove ¹H-¹³C coupling. About 1500-2000 transients are stored in 32K data points using a spectral window of 6000 or 9000 Hz. The assignments of the spectra are made referring to Kakugo [M. Kakugo, Y. Naito, K. Mizunuma and T. Miyatake, Macromolecules, 15, 4, 1150, (1982)] and J. C. Randal, Macromol. Chem Phys., C29, 201 (1989).

NMR samples are placed in tubes under inert gas and, if appropriate, melted. The solvent signals serves as internal standard in the NMR spectra and their chemical shift is converted into the values relative to TMS.

The branches may be short chain branches (SCB), such as C₂-C₆ side chains.

In some embodiments, the polyethylene copolymerized with 1-butene, 1-hexene or 1-octene as the 1-alkene, has from 0.001 to 20 ethyl, butyl or hexyl short chain branches/1,000 carbon atoms and from 2 to 6 ethyl, butyl or hexyl branches/1,000 carbon atoms.

In additional embodiments, the polyethylene B) has a substantially multimodal, such as bimodal, distribution in TREF analysis, where the comonomer content based on crystallization behavior is essentially independent of the molecular weight of a given polymer chain.

A TREF-multimodal distribution means that TREF analysis resolves at least two or more distinct maxima indicative of at least two differing branching rates and hence co-monomer insertion rates during polymerization reactions. TREF analysis analyzes co-monomer distribution based on short side chain branching frequency essentially independent of molecular weight, based on the crystallization behavior (Wild, L., Temperature rising elution fractionation, Adv. Polymer Sci. 8: 1-47, (1990), also see description in U.S. Pat. No. 5,008,204, incorporated herewith by reference). Optionally to TREF, more recent CRYSTAF techniques may be employed to the same end. In one embodiment, the polyethylene B) comprises at least two, including substantially two, different polymeric sub-fractions synthesized by different single-site catalysts, namely a first sub-fraction, synthesized by a non-metallocene catalyst, having a lower co-monomer content, a high vinyl group content and optionally a broader molecular weight distribution, and a second sub-fraction, synthesized by a metallocene catalyst, having a higher co-monomer content.

Typically, the z-average molecular weight of the first or non-metallocene sub-fraction will be smaller or ultimately substantially the same as the z-average molecular weight of the second or metallocene sub-fraction. In certain embodiments, according to TREF analysis, 5-40% by weight, such as 20%-40% by weight of the polyethylene having the higher co-monomer content (and lower level of crystallinity) has a degree of branching of from 2 to 40 branches/1,000 carbon atoms and/or 5-40%, including 2%-40% by weight of the polyethylene having the lower co-monomer content (and higher level of crystallinity) have a degree of branching of less than 2, including from 0.01 to less than 2 branches/1,000 carbon atoms. Likewise where the polyethylene B) displays multimodal behavior, that is at least bimodal distribution in GPC analysis, such as 5-40% by weight of the polyethylene having the highest molar masses, including 10-30% by weight and 20%-30% by weight, have a degree of branching of from 1 to 40 branches/1,000 carbon atoms, including from 2 to 20 branches/1,000 carbon atoms.

Moreover, up to 15%, including up to 5% by weight of the polyethylene having the lowest molar masses has a degree of branching of less than 5 branches/1,000 carbon atoms such as less than 2 branches/1,000 carbon atoms.

Furthermore, in some embodiments at least 70% of the branches of side chains larger than CH₃ in the polyethylene B) are present in the 50% by weight of the polyethylene having the highest molar masses. The part of the polyethylene having the lowest or highest molar mass is determined by the method of solvent-non-solvent fractionation, later called Holtrup fractionation as described above. The 8 fractions are subsequently examined by ¹³C-NMR spectroscopy. The degree of branching in the various polymer fractions can be determined by means of ¹³C-NMR as described by James C. Randall, JMS-REV. Macromol. Chem. Phys. C29 (2&3), 201-317 (1989). The degree of branching reflects the co-monomer incorporation rate.

In certain embodiments, the η (vis) value of the polyethylene B) is of 0.3 to 7 dl/g, such as from 1 to 1.5 dl/g or from 1.3 to 2.5 dl/g. (vis) is the intrinsic viscosity as determined according to ISO 1628-1 and -3 in decalin at 135° C. by capillary viscosity measurement.

In some embodiments, the polyethylene B) has a mixing quality measured in accordance with ISO 13949 of less than 3, including from greater than 0 to 2.5. This value is based on the polyethylene taken directly from the reactor, i.e. the polyethylene powder without prior melting in an extruder. This polyethylene powder may be obtained by polymerization in a single reactor. The mixing quality of a polyethylene powder obtained directly from the reactor can be tested by assessing thin slices (“microtome sections”) of a sample under an optical microscope. Inhomogeneities show up in the form of specks or “white spots”. The specs or “white spots” are predominantly high molecular weight, high viscosity particles in a low viscosity matrix (see, for example, U. Burkhardt et al. in “Aufbereiten von Polymeren mit neuartigen Eigenschaften”, VDI-Verlag, Dusseldorf 1995, p. 71). Such inclusions can reach a size of up to 300 μm. They cause stress cracks and result in brittle failure. The better the mixing quality of a polymer, the fewer and smaller of these inclusions are observed. Thus, the number and size of these inclusions are counted and a grade is determined for the mixing quality of the polymer according to a set assessment scheme.

The polyethylene B) has, in certain embodiments, a degree of long chain branching λ, (lambda) of from 0 to 2 long chain branches/10,000 carbon atoms and from 0.1 to 1.5 long chain branches/10,000 carbon atoms. The degree of long chain branching λ(lambda) can be measured by light scattering as described, for example, in ACS Series 521, 1993, Chromatography of Polymers, Ed. Theodore Provider; Simon Pang and Alfred Rudin: Size-Exclusion Chromatographic Assessment of Long-Chain Branch Frequency in Polyethylenes, page 254-269.

Any of the additives generally employed in the art can be present in the polyethylene composition of the disclosure.

Examples are non-polymeric additives such as lubricants and/or stabilizers.

In general, mixing of A) and B) and of optional additives can be carried out by all known methods, including directly by means of an extruder such as a twin-screw extruder. The polyethylene B) is obtainable using the catalyst system described below. In some embodiments, a single site catalyst or catalyst system is employed for providing the polyethylene component B). In certain embodiments, the present disclosure employs a catalyst composition comprising at least two different single-site polymerization catalysts a) and b), of which a) is at least one metallocene polymerization catalyst, such as a hafnocene, and b) is at least one polymerization catalyst based on a non-metallocene transition metal complex, including where b) is an iron complex component having a tridentate ligand.

Suitable metallocene and hafnocene catalysts a) are referenced and disclosed in WO 2005/103096, the disclosure being incorporated herewith, which includes hafnocenes of the general formula (VII).

In additional embodiments, hafnocene catalysts where the hafnium atom forms a complex with two cyclopentadienyl, indenyl or fluorenyl ligands are utilized, each ligand being optionally substituted with one or more C₁-C₈-alkyl and/or C₆-C₈ aryl groups, the free valencies of the hafnium atom being saturated with a halogen, such as chlorine, or C₁-C₄ alkyl or benzyl groups, or a combination of them.

Specific examples are:
bis (cyclopentadienyl) hafnium dichloride,
bis (indenyl) hafnium dichloride,
bis (fluorenyl) hafnium dichloride,
bis (pentamethylcyclopentadienyl) hafnium dichloride,
bis (ethylcyclopentadienyl) hafnium dichloride,
bis (isobutylcyclopentadienyl) hafnium dichloride,
bis (3-butenylcyclopentadienyl) hafnium dichloride,
bis (methylcyclopentadienyl) hafnium dichloride,
bis (1,3-di-tert-butylcyclopentadienyl) hafnium dichloride,
bis (tert-butylcyclopentadienyl) hafnium dichloride,
bis (n-butylcyclopentadienyl) hafnium dichloride,
bis (phenylcyclopentadienyl) hafnium dichloride,
bis (1,3-dimethyl-cyclopentadienyl) hafnium dichloride,
bis (1-n-butyl-3-methylcyclopentadienyl) hafnium dichloride,

and also the corresponding dimethylhafnium compounds.

Suitable catalysts for use as b) include iron complexes having a tridentate ligand bearing at least two aryl radicals, including aryl radicals bearing a halogen or tertiary alkyl substituent in the ortho-position.

Such iron complexes for use as b) are disclosed in WO 2005/103096, incorporated herewith by reference.

In additional embodiments, tridentate ligands for use in the present technology include 2,6-bis[1-(phenylimino)ethyl] pyridine and corresponding compounds wherein the two phenyl groups are substituted in the ortho-position with a halogen or tertiary alkyl substituent, such as a chlorine or tert-butyl group, the free valencies of the iron atom being saturated with halogen, including chlorine, or C₁-C₁₀ alkyl, or C₂-C₁₀ alkenyl, or C₆-C₂₀ aryl groups, or a combination thereof.

The preparation of the compounds b) is described, for example, in J. Am. Chem. Soc. 120, p. 4049 ff. (1998), J. Chem. Soc., Chem. Commun. 1998, 849, and WO 98/27124.

Examples of complexes for use as b) are:
2,6-Bis[1-(2-tert.butylphenylimino)ethyl]pyridine iron(II) dichloride;
2,6-Bis[1-(2-tert.butyl-6-chlorophenylimino)ethyl]pyridine iron(II) dichloride;
2,6-Bis[1-(2-chloro-6-methylphenylimino)ethyl]pyridine iron(II) dichloride;
2,6-Bis[1-(2,4-dichlorophenylimino)ethyl]pyridine iron(II) dichloride;
2,6-Bis[1-(2,6-dichlorophenylimino)ethyl]pyridine iron(II) dichloride;
2,6-Bis[1-(2,4-dichlorophenylimino)methyl]pyridine iron(II) dichloride;
2,6-Bis[1-(2,4-dichloro-6-methylphenylimino)ethyl]pyridine iron(II) dichloride;
2,6-Bis[1-(2,4-difluorophenylimino)ethyl]pyridine iron(II) dichloride;
2,6-Bis[1-(2,4-dibromophenylimino)ethyl]pyridine iron(II) dichloride;
2,6-Bis[1-(4,6-dimethyl-2-chloro-phenylimino) ethyl]pyridine iron(II) dichloride;

or the respective trichlorides, dibromides or tribromides.

In certain embodiments, one hafnocene a) is used as the catalyst under the same reaction conditions in the homopolymerization or copolymerization of ethylene in a single reactor along with one complex b), wherein a) produces a higher M_{w} than does the complex b). In a further embodiment, both the components a) and b) are supported. The two components a) and b) can in this case be applied to different supports or together on a joint support, where in certain embodiments a joint support is used to ensure a relatively close spatial proximity of the various catalyst centers and ensure good mixing of the different polymers formed. Support materials, as well as the use of activator components in addition to the catalyst, otherwise called co-catalysts, are disclosed in WO 2005/103096, incorporated herewith by reference.

The use of co-catalyst components is known in the art of ethylene polymerization, as are the polymerization processes, with reference made to WIPO Pat. App. Pub. No. WO 2005/103096.

As support materials, silica gel, magnesium chloride, aluminum oxide, mesoporous materials, aluminosilicates, hydrotalcites and organic polymers such as polyethylene, polypropylene, polystyrene, polytetrafluoroethylene or polymers bearing polar functional groups may be used, for example copolymers of ethylene and acrylic esters, acrolein or vinyl acetate.

The inorganic supports, like silica, can be subjected to a thermal treatment, e.g. to remove adsorbed water.

Such a drying treatment is generally carried out at temperatures in the range from 50 to 1000° C., such as from 100 to 600° C., with drying at from 100 to 200° C. being carried out, in certain embodiments, under reduced pressure and/or under a blanket of inert gas (e.g. nitrogen), or the inorganic support can be calcined at temperatures of from 200 to 1000° C. to produce the desired structure of the solid and/or set the desired —OH concentration on the surface. The support can also be treated chemically using customary dessicants such as metal alkyls, including aluminum alkyls, chlorosilanes or SiCl₄, or methylaluminoxane. Appropriate treatment methods are described, for example, in WIPO Pat. App. Pub. No. WO 00/31090.

As a joint activator (co-catalyst) for the catalyst components a) and b), an aluminoxane, such as mono-methylaluminoxane (MAO), may be used.

The catalyst component a) may be applied in such an amount that the concentration of the transition metal from the catalyst component a) in the finished catalyst system is from 1 to 200 μmol, such as from 5 to 100 μmol and from 10 to 70 μmol, per g of support. The catalyst component b) may be applied in such an amount that the concentration of iron from the catalyst component b) in the finished catalyst system is from 1 to 200 μmol, including from 5 to 100 μmol and from 10 to 70 μmol, per g of support.

The molar ratio of catalyst component a) to activator (co-catalyst) can be from 1:0.1 to 1:10000, such as from 1:1 to 1:2000. The molar ratio of catalyst component b) to activator (co-catalyst) may also be in the range from 1:0.1 to 1:10000, preferably from 1:1 to 1:2000.

In some embodiments, the catalyst component a), the catalyst component b) and the activator (co-catalyst) are all supported on the same support by contacting them with the support in suspension in a solvent, such as a hydrocarbon having from 6 to 20 carbon atoms, including xylene, toluene, pentane, hexane, heptane or a mixture thereof.

The process for polymerizing ethylene, alone or with 1-alkenes, can be generally carried out at temperatures in the range from 0 to 200° C., including from 20 to 200° C. and from 25 to 150° C., and under pressures from 0.005 to 10 MPa. The polymerization can be carried out in a known manner in bulk, in suspension, in the gas phase or in a supercritical medium in the customary reactors used for the polymerization of olefins.

The mean residence times are, in some embodiments, from 0.5 to 5 hours, such as from 0.5 to 3 hours. The pressure and temperature ranges for carrying out the polymerizations usually depend on the polymerization method.

Among the polymerization processes, in certain embodiments gas-phase polymerization is used, such as gas-phase fluidized-bed reactors, solution polymerization and suspension (slurry) polymerization in loop reactors and stirred tank reactors.

In some embodiments, hydrogen is used as a molar mass regulator.

Furthermore, additives such as antistatics can be used in the polymerizations.

The polymerization may be carried out in a single reactor, such as in a gas-phase or slurry reactor.

The polyethylene composition of the present disclosure can be processed on conventional injection molding machines. The finish on the moldings obtained is homogeneous and can be improved further by increasing the rate of injection or raising the mold temperature.

The present disclosure also provides an injection molded article comprising the polyethylene composition of the technology.

An injection molded article can be a container, such as a tank, having a large volume, such as a container of at least 5 L volume, including from 5 to 100 L and from 10 to 100 L.

An injection molded article can also be an inner part of a tank, e.g. a slosh baffle.

In particular, for “comprising” it is intended that the injection molded article comprises from 50% to 100% by weight of the polyethylene composition of the technology.

When the container is obtained by sealing together two injection molded half shells, very low warpage of the polyethylene composition of the disclosure is desirable, because the resulting half shells are easily sealable due to their good planarity.

### Examples

The following examples are included to demonstrate certain embodiments of the disclosure. It should be appreciated by those of skill in the art that the techniques disclosed in the examples which follow represent techniques discovered to function well in the practice of the technology. However, those of skill in the art should, in light of the present disclosure, appreciate that many changes can be made in the specific embodiments which are disclosed and still obtain a like or similar result without departing from the spirit and scope of the disclosure.

Unless differently stated, the following test methods are used to determine the properties reported in the detailed description and in the examples.

The density [g/cm³] was determined in accordance with ISO 1183 at 23° C.

The determination of the molar mass distributions and the means Mₙ, M_{w}, M_{z} and M_{w}/Mₙ derived therefrom was carried out by high-temperature gel permeation chromatography using a method essentially described in DIN 55672-1:1995-02 (February 1995). The methodological deviations applied in view of the mentioned DIN standard are as follows: the solvent was 1,2,4-trichlorobenzene (TCB), the temperature of apparatus and solutions was 135° C. and a PolymerChar (Valencia, Paterna 46980, Spain) IR-4 infrared detector, capable for use with TCB, was used for concentration detection.

A WATERS Alliance 2000 equipped with the precolumn SHODEX UT-G and separation columns SHODEX UT 806 M (3×) and SHODEX UT 807 connected in series was used. The solvent was vacuum distilled under nitrogen and was stabilized with 0.025% by weight of 2,6-di-tert-butyl-4-methylphenol. The flow rate used was 1 ml/min, the injection volume was 500 μl and the polymer concentration was in the range of 0.01%<conc.<0.05% w/w. The molecular weight calibration was established by using monodisperse polystyrene (PS) standards from Polymer Laboratories (now Varian, Inc., Essex Road, Church Stretton, Shropshire, SY6 6AX,UK) in the range from 580 g/mol up to 11600000 g/mol and, additionally, hexadecane. The calibration curve was then adapted to polyethylene (PE) by means of the Universal Calibration method (Benoit H., Rempp P. and Grubisic Z., & in J. Polymer Sci., Phys. Ed., 5, 753(1967)). The Mark-Houwing parameters used were for PS: k_{PS}=0.000121 dl/g, a_{PS}=0.706 and for PE k_{PE}=0.000406 dl/g, a_{PE}=0.725, valid in TCB at 135° C. Data recording, calibration and calculation was carried out using NTGPC_Control_V6.02.03 and NTGPC_V6.4.24 (hs GmbH, Hauptstraβe 36, D-55437 Ober-Hilbersheim), respectively.

The environmental stress cracking resistance of polymer samples is determined in accordance with international standard ISO 16770 (FNCT) in aqueous surfactant solution. From the polymer sample a compression molded 10 mm thick sheet has been prepared. The bars with squared cross section (10×10×100 mm) are notched using a razor blade on four sides perpendicular to the stress direction. A notching device as described in M. Fleissner in Kunststoffe 77 (1987), pp. 45 is used for the sharp notch with a depth of 1.6 mm. The load applied is calculated from tensile force divided by the initial ligament area. The ligament area is the remaining area=total cross-section area of specimen minus the notch area. For FNCT specimen: 10×10 mm²−4 times of trapezoid notch area=46.24 mm² (the remaining cross-section for the failure process/crack propagation). The test specimen is loaded with standard condition suggested by the ISO 16770 with a constant load of 4 MPa at 80° C. in a 2% (by weight) water solution of non-ionic surfactant ARKOPAL N100. The time until the rupture of test specimen is then detected.

The Charpy impact strength acN was determined according to ISO 179 at −30° C.

The spiral flow test was measured on a Demag ET100-310 with a closing pressure of 100 t and a 3 mm die and with a stock temperature of 250° C., an injection pressure of 1000 bar, a screw speed of 90 mm/s, a mold temperature of 30° C. and a wall thickness of 2 mm.

Preparation of the Individual Catalyst Components

Bis(n-butylcyclopentadienyl)hafnium dichloride was used as commercially available from Crompton Ltd.

2,6-bis[1-(2,4-dichloro-6-methylphenylimino)ethyl]pyridine iron(II) dichloride was prepared as described in the examples of WIPO Pat. App. Pub. No. WO2005103096.

Support Pretreatment

XPO-2107, a spray-dried silica gel from Grace, was baked at 600° C. for 6 hours.

Preparation of the Mixed Catalyst System

The mixed catalyst system was prepared as described in Example 1 of WIPO Pat. App. Pub. No. WO2005103096.

Polymerization

Using the above prepared catalyst, the polymerization was carried out in a fluidized-bed reactor having a diameter of 0.5 m as described in Example 1 of WIPO Pat. App. Pub. No. WO2005103096, but with the following differences in processing conditions:

The polymerization temperature and pressure were 102° C. and 24 bar. Ethylene was fed to the reactor at a rate of 53 kg per h, 1-hexene at a rate of 1600 g per h and hydrogen at 1.71 per h.

The polymer was discharged at 51 kg/h.

The properties of the polymer obtained are reported in Table 1.

TABLE I

| | | Example |
|---|---|---|
| Properties | Unit | Ex. 1 |
| Density | g/cm³ | 0.944 |
| MI 2.16 kg (MIE) | g/10 min. | 2.6 |
| MI 21.6 kg (MIF) | g/10 min. | 120 |
| MIF/MIE | | 46 |
| M_{w} | g/mol | 110000 |
| Mₙ | g/mol | 13500 |
| M_{w}/Mₙ | | 8.1 |
| FNCT | h | 5 |
| Spiral length | mm | 260 |
| Charpy acN - 30° C. | kJ/m² | 5.7 |

### Example 1

The polyethylene product obtained from the polymerization step was mixed with 1% by weight of carbon black (e.g. Elftex TP), resulting in a density of 0.955 g/cm³, and used for injection molding of two large complicated shaped half shells having an uneven wall and a variation of wall thickness. The polyethylene composition of the present disclosure allows for injection molded objects having high FNCT (Full Notch Creep Test, according to ISO 16770:2004 E, at 6 MPa, 50° C.). Furthermore, the polyethylene composition allows for easier processing due to its enhanced melt flow rate comprising a lower injection molding pressure. The two large complicated shaped half shells show a low tendency of warpage and are therefore easily sealable due to good planarity. Those two half shells forming an injection molded tank were tested under pressure and succeeded at a pressure of 3.6 bar.

### Example 2

The polyethylene product obtained from the polymerization step was mixed with 1% by weight of carbon black (e.g. Elftex TP) as well as 0.5% by weight of the HALS UV stabilizer Tinuvin, thus obtaining a density of 0.955 g/cm³, and used for injection molding two large complicated shaped half shells having an uneven wall and a variation of wall thickness. The polyethylene composition of the present disclosure allows of devising injection molded objects having high FNCT (Full Notch Creep Test, according to ISO 16770:2004 E, at 6 MPa, 50° C.). Furthermore, the polyethylene composition allows for easier processing due to its enhanced melt flow rate comprising a lower injection molding pressure. The two large complicated shaped half shells show a low tendency of warpage and are therefore easily sealable due to good planarity. The two half shells forming an injection molded tank were tested under pressure and succeeded at a pressure of 3.6 bar.

Although the present disclosure and its advantages has been described in detail, it should be understood that various changes, substitutions and alterations can be made herein without departing from the spirit and scope of the technology as defined by the appended claims. Moreover, the scope of the present application is not intended to be limited to the particular embodiments of the process, machine, manufacture, compositions of matter, means, methods and steps described in the specification. As one of the ordinary skill in the art will readily appreciate from the present disclosure, processes, machines, manufacture, compositions of matter, means, methods, or steps, presently existing or later to be developed that perform substantially the same function or achieve substantially the same result as the corresponding embodiments described herein may be utilized according to the present technology. Accordingly, the appended claims are intended to include within their scope such processes, machines, manufacture, compositions of matter, means, methods, or steps.

1. A polyethylene composition having density from 0.943-1.1 g/cm³, comprising:
A) carbon black, or a UV stabilizer, or a mixture of carbon black and a UV stabilizer;
B) a polyethylene comprising copolymers of ethylene with 1-alkenes, or mixtures of ethylene homopolymers and copolymers of ethylene with 1-alkenes, where the polyethylene has a molar mass distribution width (MWD) M_{w}/Mₙ of from 7-15, a density of from 0.942-0.954 g/cm³, determined according to ISO 1183 at 23° C., a weight average molar mass M_{w} of from 20,000 g/mol-500,000 g/mol, a MIE of from 1.0-3.0 g/10 min, a MIF of from 100-200 g/10 min, and a ratio MIF/MIE of from 40-50, where MIE is the melt flow rate at 190° C. with a load of 2.16 kg and MIF is the melt flow rate at 190° C. with a load of 21.6 kg, both determined according to ISO 1133.

2. The polyethylene composition of claim 1, comprising 0.25-50% by weight of carbon black and/or 0.01-10% by weight of a UV stabilizer A), all amounts being referred to the total weight of A)+B).

3. The polyethylene composition of claim 1, wherein B) contains from 0.7 to 20 CH₃/1000 carbon atoms as determined by ¹³C-NMR.

4. The polyethylene composition of claim 1, wherein B) comprises at least one C₃-C₂₀-alpha-olefin monomer species in an amount greater than 3.5% by weight based on the total weight of polyethylene.

5. The polyethylene composition of claim 1, wherein B) has a vinyl group content of at least 0.6 vinyl groups/1000 C atoms, and wherein the amount of the polyethylene comprising a molar mass of below 10⁶ g/mol, as determined by GPC, is above 95.5% by weight, based on the total weight of the polyethylene.

6. The polyethylene composition of claim 1, wherein B) has a η(vis) value of from 0.3-7 dl/g, wherein η(vis) is the intrinsic viscosity as determined according to ISO 1628-1 and ISO 1628-3 in decalin at 135° C.

7. The polyethylene composition of claim 1, wherein B) is obtainable in one polymerization step in a single reactor by a mixed catalyst system comprising at least one metallocene.

8. The polyethylene composition of claim 7, wherein B) is obtainable by polymerization in the presence of a catalyst composition comprising at least two different single-site polymerization catalysts, comprising at least one hafnocene (a) and at least one iron component (b) having a tridentate ligand bearing at least two aryl radicals, with each aryl radicals bearing a halogen or tertiary alkyl substituent in the ortho-position.

9. The polyethylene composition of claim 8, wherein B) is obtainable by copolymerizing ethylene with one or several C₃-C₂₀-alpha-olefin monomer species at a temperature of from 20-200° C. and at a pressure of from 0.05-10 MPa.

10. The polyethylene composition of claim 1, further comprising non-polymeric additives such as lubricants and/or stabilizers.

11. An injection molded article, comprising the polyethylene composition of claim 1.

12. The injection molded article of claim 11, comprising a container of at least 5 L.

13. The injection molded article of claim 11, which is an inner part of a tank.

14. The injection molded article of claim 12, comprising a container of 5-100 L.

15. The injection molded article of claim 13, comprising a slosh baffle.
